(19) United States
(12) Patent Application Publication
(10) Pub. No.: US 2026/0250169 A1
(43) Pub. Date: Aug. 27, 2026

(54) MEMBRANE BIOREACTOR WASTEWATER TREATMENT USING CALCIUM CARBONATE

(71) Applicant: Omya International AG, Oftringen (CH)

(72) Inventors: Nicholas Charles NELSON, Zürich (CH); Jan STEMANN, Inzlingen (DE)

(73) Assignee: Omya International AG, Oftringen (CH)

(21) Appl. No.: 18/992,431

(22) PCT Filed: Jul. 12, 2023
(86) PCT No.: PCT/EP2023/069319

§ 371 Date: Jan. 8, 2025

(30) Foreign Application Priority Data
Jul. 15, 2022 (EP) 22185239.5

(51) Int. Cl. C02F 3/12

(52) U.S. Cl. CPC C02F 3/1205; C02F 3/1273; C02F 2303/20

(57) ABSTRACT

The present invention relates to a process for the treatment of wastewater in the membrane bioreactor (MBR) process using at least one membrane module, characterized by the steps of a) providing wastewater, b) contacting the wastewater of step a) with the at least one membrane module in the presence of sludge, c) adding calcium carbonate to the wastewater of step a) before and/or during step b); the use of calcium carbonate in such a process, a method for increasing the membrane permeability in a membrane bioreactor (MBR) process using at least one membrane module by adding calcium carbonate, as well as a method for increasing the membrane flux rate in a membrane bioreactor (MBR) process using at least one membrane module by adding calcium carbonate.

The present invention relates to a process for the treatment of wastewater in membrane bioreactor (MBR) processes using at least one membrane module in the presence of sludge, the use of calcium carbonate in such a process, a method for increasing the membrane permeability in a membrane bioreactor (MBR) process using at least one membrane module, as well as a method for increasing the membrane flux rate in a membrane bioreactor (MBR) process using at least one membrane module.

Membrane bioreactor wastewater treatment is a combination of a membrane process like microfiltration or ultrafiltration with a biological wastewater treatment process, such as the activated sludge process, and is widely used for municipal and industrial wastewater treatment.

The activated sludge process is a type of process for treating sewage or industrial wastewaters using aeration and a biological floc composed of bacteria and protozoa. In a sewage (or industrial wastewater) treatment plant, the activated sludge process is a biological process that can be used for oxidizing carbonaceous biological matter, oxidizing nitrogenous matter, mainly ammonium and nitrogen in biological matter, removing nutrients (nitrogen and phosphorus).

The process takes advantage of aerobic micro-organisms that can digest organic matter in sewage, and clump together (by flocculation) as they do so. It thereby produces a liquid that is relatively free from suspended solids and organic material, and flocculated particles that will readily settle out and can be removed.

In a membrane bioreactor, the separation and further purification is achieved by membranes. When used with domestic wastewater, membrane bioreactor MBR processes can produce effluent of high quality enough to be discharged to the coastal, surface, or brackish waterways or to be reclaimed for urban irrigation. Other advantages of MBRs over conventional processes include small footprint, easy retrofit, and upgrading old wastewater treatment plants.

It is possible to operate MBR processes at higher mixed liquor suspended solids (MLSS) concentrations compared to conventional settlement separation systems, thus reducing the reactor volume to achieve the same loading rate.

There are two MBR configurations, namely immersed/submerged membrane bioreactor configuration (iMBR), where the membranes are submerged in and integral to the biological reactor, and external/sidestream membrane bioreactor configuration (sMBR), where membranes are a separate unit process requiring an intermediate pumping step.

In the submerged membrane bioreactor (IMBR) configuration, the filtration element is installed in either the main bioreactor vessel or in a separate tank. The modules are positioned above an aeration system, fulfilling two functions: the supply of oxygen for the biological process, and the scouring of the surface of the membranes, to minimize the amount of build-up. The membranes can be a flat sheet or hollow fibre or a combination of both and can incorporate an online backwash system which reduces membrane surface fouling by pumping membrane permeate back through the membrane. In systems where the membranes are in a separate tank to the bioreactor, individual trains of membranes can be isolated to undertake cleaning regimes incorporating membrane soaks, however, the biomass must be continuously pumped back to the main reactor to limit MLSS concentration increase. Additional aeration is also required to provide air scour to reduce fouling. Where the membranes are installed in the main reactor, membrane modules have to be removed from the vessel and transferred to an offline cleaning tank. Usually, a concentration of mixed liquor suspended solids which approaches to 10.000 mg/l, is used, in order to guarantee a good mass transfer of oxygen with a good permeate flux.

In the sMBR technology, where the filtration modules are outside the aerobic tank, the aeration system is also used to clean and supply oxygen to the bacteria degrading the organic compounds. The biomass is either pumped directly through a number of membrane modules in series and back to the bioreactor, or the biomass is pumped to a bank of modules, from which a second pump circulates the biomass through the modules in series. Cleaning and soaking of the membranes can be undertaken in place with the use of an installed cleaning tank, pump, and pipework. The quality of the final product is such that it can be reused in process applications due to the filtration capacity of the micro and ultrafiltration membranes.

The MBR filtration performance inevitably decreases with filtration time. This is due to the deposition of soluble and particulate materials onto and into the membrane, attributed to the interactions between activated sludge components and the membrane. This major drawback and process limitation has been under investigation since the early MBRs, and remains one of the most challenging issues facing further MBR development.

Membrane fouling is the most serious problem affecting system performance. Fouling leads to a significant increase in hydraulic resistance, manifested as permeate flux decline or transmembrane pressure (TMP) increase when the process is operated under constant-TMP or constant-flux conditions respectively. In systems where flux is maintained by increasing TMP, the energy required to achieve filtration increases. Alternatively, frequent membrane cleaning is therefore required, increasing significantly the operating costs as a result of cleaning agents and production downtime. More frequent membrane replacement is also expected.

Membrane fouling results from the interaction between the membrane material and the components of the activated sludge liquor, which include biological flocs formed by a large range of living or dead microorganisms along with soluble and colloidal compounds. The suspended biomass has no fixed composition and varies with feed water composition and MBR operating conditions.

There are several strategies to reduce fouling and optimize the performance of the MBR operation, such as, e.g.
Applying an appropriate pre-treatment to the feed water, e.g. decreasing the solids loading to the membrane, which decreases the fouling of the membranes, but on the other hand also decreases valuable biology required to breakdown ammonium and other components;
Chemically or biochemically modifying the mixed liquor (the feed) by the addition of inorganic coagulants such as ferric chloride, aluminium sulphate, poly-aluminium chloride, which improves settling of solids in the reactor, but on the other hand increases deposition and fouling on the membrane surface, further acidifies the mixed liquor, slows down the biology, and causes additional product consumption;
Increased scouring of the membrane surface through cross-flow aeration, which decreases fouling, but, on the other hand, is energy intensive, has a limited impact, decreases the contact between mixed liquor and membrane surface.

Accordingly, there is still a need to optimize the operation of membrane bioreactors in wastewater treatment.

It has been found that the use of calcium carbonate surprisingly has several positive effect in this respect, especially as regards the prevention of fouling at the membrane.

Generally, the presence of calcium carbonate in the activated sludge process is known. However, calcium carbonate has not been applied in membrane bioreactor systems yet, as it is known that the presence of carbonates may lead to considerable and serious scaling problems in membrane bioreactors, i.e. it rather had to be expected that the fouling problem is increased instead of decreased.

Therefore, it is a surprising finding that calcium carbonate can also be employed in membrane bioreactor processes, and not only decreases fouling, but even improves membrane performance.

When the activated sludge process is combined with a membrane bioreactor for filtration of the treated water, the use of calcium carbonate has the particular advantage of improving the membrane performance, especially in terms of
increased flux rates through the membranes, i.e. increased throughput,
decrease of the total membrane area,
increased permeability, i.e. decreased pumping power,
decrease of the specific aeration demand to control fouling,
extension of the intervals for the cleaning cycles of the membranes,
decreased chemical cleaning, i.e. increased lifespan of the membranes.

Without wishing to be bound by theory, it is believed that this is due to the following effects:
1. Dissolved calcium ions “bridge” biomass to create larger bio flocs that is less likely to foul the membrane surface. It is believed that calcium cations improve the floc formation and thereby reduce organic bio-fouling which is known to be the main reason for reduced membrane permeability (see FIG. 1);
2. Undissolved calcium carbonate helps providing “channels” for the passage of water through the activated sludge increasing the permeability of an activated sludge film.

Furthermore, acidification of the wastewater coming from the nitrification/denitrification process (break-down of ammonium into nitrogen compounds) and the dosing of coagulants decreases the pH. The addition of calcium carbonate stabilizes the pH of the wastewater and provides a natural buffer by dissolving the calcium carbonate into calcium and bicarbonate species.

The most common chemicals for pH/alkalinity adjustment in MBRs are sodium hydroxide (NaOH), magnesium hydroxide (Mg(OH)₂), and lime (Ca(OH)₂). The most common way to provide calcium ions to wastewater treatment is by adding calcium chloride (CaCl₂)) or hydrated lime (Ca(OH)₂). For all of the substances above, however, there is a risk of calcite precipitation, if the solubility equilibrium of calcium carbonate is surpassed. Calcite scaling is of serious concern for MBR plants, as this can greatly reduce the permeability of membranes.

Calcite scaling is provoked by precipitation of dissolved calcium cations and carbonate anions but not by deposition of solid calcium carbonate particles as such. Calcite precipitation takes place when a solution is oversaturated with respect to dissolved carbonate anions and calcium cations.

The solubility equilibrium of calcium carbonate mainly depends on the concentration of carbonate anions and calcium cations. The solubility product of calcium carbonate Kₛₚ=[Ca²⁺]*[CO₃²⁻] is low (ca. 5*10⁻⁹). The solubility equilibrium of dissolved species can be expressed according to the following relation: CaCO₃≈Ca²⁺+CO₃²⁻ As carbonic acid is a polyprotic acid the concentration of the carbonate anion (CO₃²⁻) depends on the total concentration of dissolved carbonic acid species (CO₃²⁻, HCO₃⁻, and CO_{2,aq}) and the pH. At low pH, CO_{2,aq} is the dominant species, and, at high pH, CO₃²⁻ is the dominant species. In turn the solubility of CaCO₃ greatly decreases with an increase of pH.

So calcite precipitation can also be induced by NaOH or Mg(OH)₂ dosage by pH elevation and shift of bicarbonate to the carbonate species. The outstanding advantage of the use of calcium carbonate for pH/alkalinity adjustment is that the solubility equilibrium cannot be surpassed by product dosage. In case the product dosage is higher than the solubility, CaCO₃ will simply not further dissolve. It is important to note that the formation of calcite scale is provoked by precipitation of dissolved and not by deposition of calcium carbonate particles.

The Langelier Saturation Index (LSI) is a measure to evaluate if a water is over- or undersaturated with respect to calcium and carbonate ions. A water that contains more calcium and carbonate ions than the solubility limit allows has a positive LSI and is oversaturated with respect to calcium carbonate, whereas a water with less calcium and carbonate ions than the solubility limit is undersaturated and has a negative LSI.

The “Langelier Saturation Index” (LSI) as used herein describes the tendency of an aqueous liquid to be scale-forming or corrosive, with a positive LSI indicating scale-forming tendencies and a negative LSI indicating a corrosive character. A balanced Langelier Saturation Index, i.e. LSI=0, therefore means that the aqueous liquid is in chemical balance. The LSI is calculated as follows:

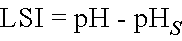

wherein pH is the actual pH value of an aqueous system and pHs is the pH value of the aqueous system at CaCO₃ saturation. The pHs can be estimated as follows:

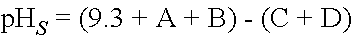

wherein A is the numerical value indicator of total dissolved solids (TDS) present in the aqueous liquid, B is the numerical value indicator of temperature of the aqueous liquid, C is the numerical value indicator of the calcium concentration of the aqueous liquid as CaCO₃, and D is the numerical value indicator of alkalinity of the aqueous liquid as CaCO₃. The parameters A to D are determined using the following equations:

$$A = ( {log}_{10} ( TDS ) - 1 ) / 10$$

$$B = - 13.12 \times {log}_{10} ( T + 273 ) + 34.55$$

$$C = {log}_{10} [ {Ca}^{2 +} ] - 0.4$$

$$D = {log}_{10} ( TAC )$$

wherein TDS are the total dissolved solids in mg/l, T is the temperature in ° C., [Ca²⁺] is the calcium concentration of the aqueous liquid in mg/l as CaCO₃, and TAC is the total alkalinity of the aqueous liquid in mg/l as CaCO₃.

FIGS. 2a and 2b depict the LSI as a function of pH and dissolved carbonate and calcium ions. In Scenario 1, 3 and 4, with an alkali hydroxide, a calcium chloride or a calcium hydroxide a positive Langelier saturation index (LSI) can be reached resulting in oversaturation and precipitation reactions. In Scenario 2, by pH increase with calcium carbonate, oversaturation of calcium carbonate is not possible and thus precipitation reactions and scale formation can be ruled out.

Thus, the outstanding advantage of the use of CaCO₃ for pH/alkalinity adjustment in MBR processes is that the solubility limit of CaCO₃ cannot be surpassed by product dosage. In case the product dosage is higher than the solubility, CaCO₃ will simply not further dissolve and the maximal LSI that can be reached is 0. Therefore dosage of CaCO₃ will not result in calcite scaling on membrane surfaces. On the contrary, dosage of NaOH or another alkali hydroxide may result in oversaturated conditions (expressed by LSI>0). This will induce calcite precipitation and thus calcite scale formation on membrane surfaces.

Accordingly, it is the object of the present invention to provide a process for the treatment of wastewater in the membrane bioreactor process providing an improved operation of the membrane bioreactor by e.g. an increase of the flux rates through the membranes, an increase of the permeability of the membranes, a decrease of fouling, etc.

The foregoing and other objects are solved by the subject-matter as defined in the independent claims. Advantageous embodiments of the present invention are defined in the corresponding subclaims.

It should be understood that, for the purpose of the present invention, the following terms have the following meaning:

Where an indefinite or definite article is used when referring to a singular noun, e.g., “a”, “an” or “the”, this includes a plural of that noun unless anything else is specifically stated.

Where the term “comprising” is used in the present description and claims, it does not exclude other elements. For the purposes of the present invention, the term “consisting of” is considered to be a preferred embodiment of the term “comprising”. If hereinafter a group is defined to comprise at least a certain number of embodiments, this is also to be understood to disclose a group, which preferably consists only of these embodiments.

Whenever the terms “including” or “having” are used, these terms are meant to be equivalent to “comprising” as defined hereinabove.

Terms like “obtainable” or “definable” and “obtained” or “defined” are used interchangeably. This, for example, means that, unless the context clearly dictates otherwise, the term “obtained” does not mean to indicate that, for example, an embodiment must be obtained by, for example, the sequence of steps following the term “obtained” though such a limited understanding is always included by the terms “obtained” or “defined” as a preferred embodiment.

Accordingly, in a first aspect, the present invention relates to a process for the treatment of wastewater in the membrane bioreactor (MBR) process using at least one membrane module, characterized by the steps of
a) providing wastewater,
b) contacting the wastewater of step a) with the at least one membrane module in the presence of sludge,
c) adding calcium carbonate to the wastewater of step a) before and/or during step b).

Wastewater generally is defined as used water from any combination of domestic, industrial, commercial or agricultural activities, surface runoff/stormwater, and any sewer inflow or sewer infiltration.

The process of the present invention is especially useful in the treatment of sewage, i.e. domestic wastewater or municipal wastewater, which is wastewater that is produced by a community of people.

It may, however, also be used in the treatment of industrial wastewater, water-borne waste generated from a variety of industrial processes, cooling water, leachate, return flow, surface runoff, urban runoff, agricultural wastewater, etc.

Accordingly, the wastewater to be treated may be selected from the group comprising municipal wastewater, industrial wastewater, and mixtures thereof.

Generally, wastewater, which can be treated in the process of the present invention is defined as water comprising dissolved or suspended materials summarized by the following parameters:

| | |
|---|---|
| Chemical oxygen demand | 200-10000 mg/l |
| Total organic carbon | 150-7000 mg/l |
| Ammonium | 5-500 mg/l |
| Total nitrogen | 10-1000 mg/l |
| Total suspended solids | 50-10000 mg/l |

Sludge in the meaning of the present invention means any type of sludge contained in wastewater. In this respect, sludge comprises any type of sludge originally contained in the wastewater before the wastewater treatment, sludge added during the wastewater treatment, sludge recycled in the wastewater treatment process, so called return activated sludge, sludge precipitated or chemically or biologically modified during the wastewater treatment processes, or mixtures thereof.

Sludge present in the wastewater according to the present invention may comprise raw sludge, i.e. untreated non-stabilized sludge.

Furthermore sludge according to the present invention may comprise primary sludge, i.e. sludge which is produced through the mechanical wastewater treatment process. It occurs after the screen and the grit chamber and consists of undissolved wastewater contaminations. The sludge amassing at the bottom of the primary sedimentation basin is also called primary sludge. Primary sludge may consist to a high portion of organic matters, as faeces, vegetables, fruits, textiles, paper etc.

Furthermore, sludge according to the present invention may comprise activated sludge. The removal of dissolved organic matter and nutrients from the wastewater takes place in the biological treatment step. It is done by the interaction of different types of bacteria and microorganisms, which require oxygen to live, grow and multiply in order to consume the organic matter as described further below. The resulting sludge from this process is called activated sludge. The activated sludge exists normally in the form of flocs, which besides living and dead biomass contain adsorbed, stored, as well as organic and mineral parts.

The sedimentation behaviour of the activated sludge flocs is of great importance for the function of the biological treatment. The flocs must be well removable, so that the biomass can be separated from the cleaned wastewater without problems and a required volume of activated sludge can be pumped back into the aerated part.

Generally, in a first step of the wastewater treatment, the wastewater usually is subjected to a primary treatment step, which includes the removal of a portion of the suspended solids and organic matter from the sewage. It consists of allowing sewage to pass slowly through a basin, where heavy solids can settle to the bottom, while oil, grease and lighter solids float to the surface and are skimmed off. The settled and floating materials are removed and the remaining liquid may be discharged or subjected to a secondary treatment.

The secondary treatment is the removal of biodegradable organic matter (in solution or suspension) from sewage or similar kinds of wastewater. The aim is to achieve a certain degree of effluent quality in a sewage treatment plant suitable for the intended disposal or reuse option. During secondary treatment, biological processes are used to remove dissolved and suspended organic matter measured as biochemical oxygen demand (BOD). These processes are performed by microorganisms in a managed aerobic or anaerobic process depending on the treatment technology. Bacteria and protozoa consume biodegradable soluble organic contaminants (e.g. sugars, fats, and organic short-chain carbon molecules from human waste, food waste, soaps and detergent) while reproducing to form cells of biological solids.

Secondary treatment is widely used in sewage treatment and is also applicable to many agricultural and industrial wastewaters.

The membrane bioreactor process is used in the secondary treatment step, and usually involves air or oxygen being introduced into a mixture of screened, and primary treated sewage or industrial wastewater in an aeration tank combined with organisms to develop a biological floc, the activated sludge, which reduces the organic content of the sewage. This material is commonly known in the art of wastewater treatment, and is e.g. largely composed of saprotrophic bacteria, but also has an important protozoan flora component mainly composed of amoebae, spirotrichs, peritrichs including vorticellids and a range of other filter-feeding species. Other important constituents include motile and sedentary rotifers. Generally, the activated sludge comprises bacteria and protozoa adapted to a specific wastewater and capable of metabolizing pollutants present in such wastewater.

The combination of wastewater and biological mass is commonly known as mixed liquor as defined in more detail below. The mixed liquor suspended solids in the process of the present invention is preferably from 2 to 20 g/l, more preferably from 4 to 18 g/l, even more preferably from 6 to 15 g/l, most preferably from 7 to 14 g/l.

The membrane bioreactor process according to the present invention may be run as an immersed/submerged membrane bioreactor process, i.e. the membranes are submerged in and integral to the biological reactor, and/or as an external/sidestream membrane bioreactor process, i.e. the membranes are a separate unit as explained above. Accordingly, the at least one membrane module of step b) may be submerged in the bioreactor (iMBR configuration) or installed outside the bioreactor in a sidestream (sMBR configuration).

For this purpose, any commonly used submerged membrane bioreactor configuration or any commonly used external/sidestream configuration may be used. A schematic configuration of a submerged MBR and an external/sidestream MBR are shown in FIGS. 3a and b.

The at least one membrane module may be a flat sheet, hollow fibre, tubular or a combination of one or more thereof. It may be any membrane module commonly used in membrane bioreactor processes, and preferably may be made of a ceramic, polymer, or other synthetic material.

The at least one membrane module preferably has a pore size of not more than 5 μm, preferably not more than 2 μm, more preferably not more than 1.5 μm, especially preferably not more than 1.2 μm, and most preferably from 0.005 to 1 μm.

According to the invention several membrane modules may be combined having the same or different pore sizes.

It is also possible to combine submerged and external/sidestream membranes configurations.

In all activated sludge and membrane bioreactor plants, once the wastewater has received sufficient treatment, excess mixed liquor is separated from the cleaned water by settling tanks in conventional activated sludge treatment or by membranes in MBR processes. Part of the settled or filtered material, the sludge, is returned to (or remains in) the head of the aeration system to contact the new wastewater entering the tank. This fraction of the sludge is called return activated sludge (R.A.S.). The amount of return activated sludge may be different. It may be from 0 to up to 100 w %, preferably 5 to 95 wt %, more preferably 20 to 80 wt %, even more preferably 40 to 60 wt %, e.g. 50 wt % based on the total amount of sludge. Typically, 95 wt % of the sludge are returned.

Activated sludge is also the name given to the active biological material produced by activated sludge and membrane bioreactor plants. Excess sludge is called waste activated sludge and is removed from the treatment process to keep the ratio of biomass to food supplied in the wastewater in balance.

According to the invention, calcium carbonate is added before and/or during the wastewater is contacted with the at least one membrane module. The calcium carbonate may generally be added, at any point of the secondary treatment process of the wastewater treatment, such as anywhere in the feed to the secondary treatment, within the secondary treatment, into the aeration tank, within the return activated sludge stream, etc. In a preferred embodiment, the calcium carbonate is added into the return activated sludge stream.

In another preferred embodiment, one part of the added calcium carbonate is dissolved, and the other part remains undissolved. In applications which focus on pH/alkalinity adjustment, more than 50% of the calcium carbonate is dissolved. Typically even 70 to 100 wt % of the calcium carbonate is dissolved. The solubility may vary significantly as it depends on the pH of the wastewater, the concentration of dissolved calcium and carbonate as well as further dissolved anions and cations. In applications that focus on adding calcium carbonate primarily as a filtration aid, a significant fraction of calcium carbonate is not dissolved. This is achieved by adding calcium carbonate to a wastewater in excess of the amount required to achieve a neutral Langelier Saturation Index (LSI) or by dosing calcium carbonate in particle sizes that dissolve sufficiently slow to assure a sufficiently high ratio of undissolved versus dissolved calcium carbonate.

The calcium carbonate is added in an amount such that the pH and/or the total alkalinity in the process is controlled. pH control by addition of calcium carbonate is governed by the following reaction equation:

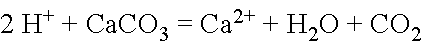

Thus, 1 mol or 100 g of CaCO₃ are required to neutralize 2 mols of H⁺.

In case of partial dissolution of CaCO₃ an adjusted higher dosage of CaCO₃ is required in practice according to the following relation:

$${m}_{C aCO 3 , a d justed} = \frac{{m}_{C aCO 3 , theoretical}}{f}$$

Where
m_{CaCO3,adjusted} is the actual required dose
m_{CaCO3,theoretical} is the required dosage suggested by stoichiometry and
f is a correction factor defined as

$$f = \frac{{m}_{C aCO 3 dissolved}}{{m}_{C aCO 3 , a d d e d}}$$

where
m_{CaCO3,dissolved} is the amount of CaCO₃ which is dissolved and
m_{CaCO3,added} is the amount of CaCO₃ added to the system

In case the pH is controlled by NaOH, the following reaction equation expresses the neutralization:

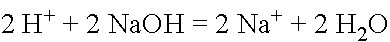

Thus, 2 mols of or 80 g of NaOH are required to neutralize 2 mols of H⁺.

Specifically, calcium carbonate is added in an amount such that the pH value in the mixed liquor comprising sludge and calcium carbonate is from 5.5 to 9, preferably from 6 to 8.5, more preferably from 6.2 to 8, even more preferably from 6.5 to 7.8, most preferably from 7 to 7.3.

In a further preferred embodiment, calcium carbonate is added in an amount such that the total alkalinity in the effluent is from 30 to 300 mg/l as CaCO₃, more preferably from 50 to 275 mg/l as CaCO₃, even more preferably from 80 to 250 mg/l as CaCO₃, most preferably from 100 to 200 mg/l as CaCO₃.

The water hardness of the effluent is preferably from 0.18 to mmol/l to 3.57 mmol/l, more preferably from 0.3 to 3.2 mmol/l, even more preferably from 0.4 to 3.0 mmol/l, most preferably from 0.5 to 2.7 mmol/l.

Furthermore, it is preferred that the Langelier Saturation Index (LSI) of the mixed liquor comprising sludge and calcium carbonate is from −1.5 to +1, preferably from −1 to +0.5, more preferably from −0.5 to 0.

According to a preferred embodiment, the maximal Langelier Saturation Index (LSI) of the mixed liquor comprising sludge and calcium carbonate is 0. According to another preferred embodiment, the Langelier Saturation Index (LSI) of the mixed liquor comprising sludge and calcium carbonate is from −1.5 to 0, preferably from −1 to 0, more preferably from −0.5 to 0.

According to one embodiment, the present invention refers to a process for the treatment of wastewater in the membrane bioreactor (MBR) process using at least one membrane module, characterized by the steps of
a) providing wastewater,
b) contacting the wastewater of step a) with the at least one membrane module in the presence of sludge,
c) adding calcium carbonate to the wastewater of step a) before and/or during step b),
wherein the Langelier Saturation Index (LSI) of the mixed liquor comprising sludge and calcium carbonate is maximal 0, preferably from −1.5 to 0, more preferably from −1 to 0, and more preferably from −0.5 to 0.

The Langelier Saturation Index (LSI) is a calculated number used to predict the calcium carbonate stability of water. It indicates whether the water will precipitate, dissolve, or be in equilibrium with calcium carbonate. The LSI is expressed as the difference between the actual system pH and the saturation pH:

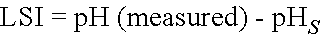

For LSI>0, water is super saturated and tends to precipitate a scale layer of CaCO₃.

For LSI=0, water is saturated (in equilibrium) with CaCO₃. A scale layer of CaCO₃ is neither precipitated nor dissolved.

For LSI<0, water is undersaturated and tends to dissolve solid CaCO₃.

If the actual pH of the water is below the calculated saturation pH, the LSI is negative and the water has a very limited scaling potential. If the actual pH exceeds pHs, the LSI is positive, and being supersaturated with CaCO₃, the water has a tendency to form scale. At increasing positive index values, the scaling potential increases.

The calcium carbonate used in the present invention preferably is selected from the group comprising natural ground calcium carbonate (GCC), mixed natural ground carbonate minerals containing calcium carbonate, precipitated calcium carbonate (PCC), and mixtures thereof.

The term natural ground calcium carbonate as used herein refers to a particulate material obtained from natural calcium carbonate containing minerals, which has been processed in a wet and/or dry comminution step, such as crushing and/or grinding, and optionally has been subjected to further steps such as screening and/or fractionation, for example, by a cyclone or a classifier. The natural ground calcium carbonate (GCC) preferably is selected from the group comprising marble, chalk, limestone, and mixtures thereof.

Mixed natural ground carbonate minerals containing calcium carbonate refer to calcium carbonate material, wherein a certain part of the calcium cations is replaced by other cations. An especially preferred example of such mixed natural ground carbonate minerals is dolomite.

“Precipitated calcium carbonate” (PCC) in the meaning of the present invention is a synthesized material, obtained by precipitation following a reaction of carbon dioxide and calcium hydroxide (hydrated lime) in an aqueous environment. Alternatively, precipitated calcium carbonate can also be obtained by reacting calcium- and carbonate salts, for example calcium chloride and sodium carbonate, in an aqueous environment. PCC may have an aragonitic, vateritic or calcitic crystal form, wherein any form may be used in the present invention, as well as mixtures thereof. PCCs are described, for example, in EP2447213 A1, EP2524898 A1, EP2371766 A1, EP2840065 A1, or WO2013142473 A1.

According to one preferred embodiment of the present invention, the calcium carbonate is in the form of particles having a weight median particle diameter d₅₀ (wt) of from 0.1 to 50 μm, preferably from 0.2 to 20 μm, more preferably from 0.5 to 10 μm, and most preferably from 1 to 5 μm.

According to a further preferred embodiment of the present invention, the calcium carbonate is in the form of particles having a top cut particle diameter d₉₈ (wt) of not more than 100 μm, preferably not more than 75 μm, even more preferably not more than 50 μm, most preferably not more than 25 μm, and especially is from 1.2 to 10 μm, e.g. from 1.6 to 5 μm.

The value dₓ represents the diameter relative to which x % of the particles have diameters less than dₓ. This means that the d₉₈ value is the particle size at which 98% of all particles are smaller. The dos value is also designated as “top cut”. The dₓ values may be given in volume or weight percent. The d₅₀ (wt) value is thus the weight median particle size, i.e. 50 wt % of all particles are smaller than this particle size, and the d₅₀ (vol) value is the volume median particle size, i.e. 50 vol % of all particles are smaller than this particle size.

According to one embodiment, the present invention refers to a process for the treatment of wastewater in the membrane bioreactor (MBR) process using at least one membrane module, characterized by the steps of
a) providing wastewater,
b) contacting the wastewater of step a) with the at least one membrane module in the presence of sludge,
c) adding calcium carbonate to the wastewater of step a) before and/or during step b),
wherein the calcium carbonate is in the form of particles having a weight median particle diameter d₅₀ (wt) of from 0.1 to 50 μm.

According to one embodiment, the present invention refers to a process for the treatment of wastewater in the membrane bioreactor (MBR) process using at least one membrane module, characterized by the steps of
a) providing wastewater,
b) contacting the wastewater of step a) with the at least one membrane module in the presence of sludge,
c) adding calcium carbonate to the wastewater of step a) before and/or during step b),
wherein the calcium carbonate is in the form of particles having a weight median particle diameter d₅₀ (wt) of from 0.1 to 50 μm and
wherein the Langelier Saturation Index (LSI) of the mixed liquor comprising sludge and calcium carbonate is maximal 0, preferably from −1.5 to 0, more preferably from −1 to 0, and more preferably from −0.5 to 0.

In a further preferred embodiment, the calcium carbonate has a BET specific surface area of from 0.1 to 100 m²/g, preferably of from 0.2 to 50 m²/g, more preferably 0.5 to 30 m²/g, even more preferably of from 0.8 to 20 m²/g, most preferably of from 1 to 12 m²/g, e.g. of from 5 to 6 m²/g.

Preferably, the calcium carbonate has a purity of at least 70 wt %, especially at least 75 wt %, more preferably at least 80 wt %, even more preferably at least 85 wt %, most preferably at least 90 wt %, e.g. 98 wt %.

In the event that a mixed natural ground carbonate mineral containing calcium carbonate is used, the purity relates to the mixed carbonate. For example, if dolomite is used, the dolomite (CaMg(CO₃)₂)) has a purity of at least 70 wt %, especially at least 75 wt %, more preferably at least 80 wt %, even more preferably at least 85 wt %, most preferably at least 90 wt %, e.g. 98 wt %.

The calcium carbonate may be provided in dry form or suspended in water. Preferably, a corresponding aqueous suspension has a content of calcium carbonate within the range of 1 wt % to 90 wt %, more preferably 10 wt % to 72 wt %, even more preferably 20 wt % to 70 wt %, especially preferably 30 wt % to 68 wt %, and most preferably 50 to 60 wt % based on the weight of the slurry.

In an especially preferred embodiment, the calcium carbonate is provided in dry form or in the form of an aqueous suspension having a solids content of at least 60 wt %, more preferably at least 68 wt %, even more preferably at least 70 wt %, most preferably at least 72 wt %.

A “dry” material may be defined by its total moisture content which, unless specified otherwise, is less than or equal to 0.5 wt. %, even more preferably less than or equal to 0.2 wt. %, and most preferably between 0.03 and 0.07 wt. %, based on the total weight of the dried material. The “total moisture content” of a material may be measured according to the Karl Fischer coulometric titration method determining the percentage of moisture (e.g. water), which may be desorbed from a sample upon heating to 220° C.

A “suspension” or “slurry” in the meaning of the present invention refers to a mixture comprising at least one insoluble solid in a liquid medium, for example water, and optionally further additives, and usually contains large amounts of solids and, thus, is more viscous (higher viscosity) and can have a higher density than the liquid medium from which it is formed.

The calcium carbonate may also be provided in the form of granules breaking up into a powdered product as described above once in water phase.

As explained above, it has been found that the addition of calcium carbonate leads to permeabilities of the at least one membrane module, which are higher than the permeabilities achieved, if no calcium carbonate is added, or, if the same equivalents of another alkali are added.

Commonly achievable permeabilities of membrane modules are in a range of from 200 to 240 l h⁻¹ m⁻² bar⁻¹.

Permeabilities achievable by the addition of calcium carbonate according to the present invention may be in a range of from 220 to 600 l h⁻¹ m⁻² bar⁻¹, preferably from 250 to 500 l h⁻¹ m⁻² bar⁻¹, more preferably from 300 to 400 l h⁻¹ m⁻² bar⁻¹, most preferably from 330 to 350 l h⁻¹ m⁻² bar⁻¹.

Thus, the permeability of the at least one membrane module may be increased by at least 10%, preferably by at least 25%, more preferably by at least 50%, even more preferably by at least 100%, most preferably by at least 150% by the addition of calcium carbonate.

It has also been found that the addition of calcium carbonate leads to flux rates through the at least one membrane module, which are higher than the flux rates achieved, if no calcium carbonate is added, or, if the same equivalents of another alkali are added.

Thus, the flux rate of the at least one membrane at a given pressure may be increased by at least 5%, preferably by at least 10%, more preferably by at least 15%, even more preferably by at least 20%, and most preferably by at least 25% by the addition of calcium carbonate.

Accordingly, the use of calcium carbonate in a process for the treatment of wastewater in a membrane bioreactor (MBR) process using at least one membrane module as described above is a further aspect of the present invention.

Furthermore, a method for increasing the membrane permeability in a membrane bioreactor (MBR) process using at least one membrane module by adding calcium carbonate as described above is a still further aspect of the present invention, wherein the permeability of the at least one membrane module is increased by at least 10%, preferably by at least 25%, more preferably by at least 50%, even more preferably by at least 100%, most preferably by at least 150% by the addition of calcium carbonate.

A further aspect of the present invention is a method for increasing the membrane flux rate at a given pressure in a membrane bioreactor (MBR) process using at least one membrane module by adding calcium carbonate as described above, wherein the flux rate of the at least one membrane module is increased by at least 5%, preferably by at least 10%, more preferably by at least 15%, even more preferably by at least 20%, and most preferably by at least 25% by the addition of calcium carbonate.

The following examples and tests will illustrate the present invention, but are not intended to limit the invention in any way.

### FIGURES

FIG. 1 shows a schematic illustration of the influence of sodium cations (scenario 1) and calcium cations (scenario 2) on floc formation and permeability.

FIGS. 2a and 2b, 2c and 2d illustrate the Langelier Saturation Index (LSI) as a function of pH and dissolved calcium and carbonate ions: Scenario 1: Dosage of alkali hydroxide; Scenario 2: Dosage of calcium carbonate; Scenario 3: Dosage of calcium chloride; Scenario 4: Dosage of calcium hydroxide.

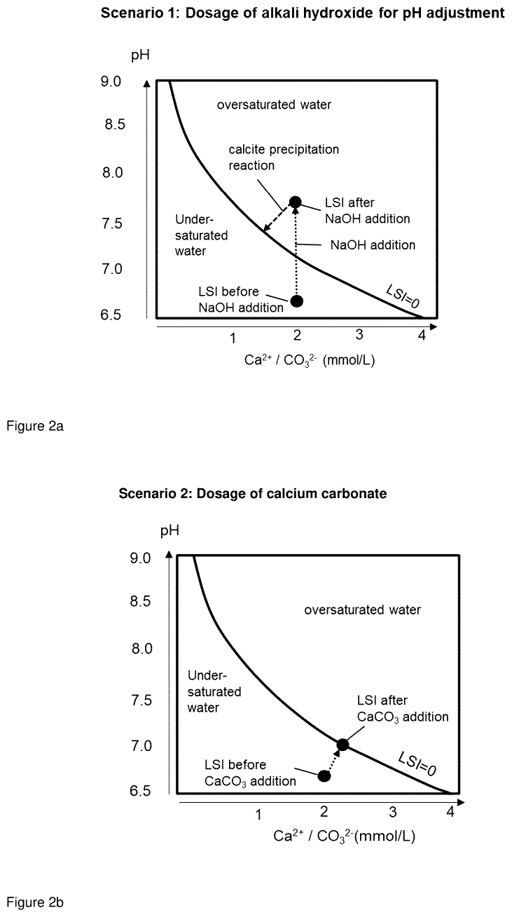

FIGS. 3a and 3b illustrate schematic configurations of a membrane bioreactor process. FIG. 3a illustrates an immersed/submerged membrane bioreactor (iMBR) configuration. FIG. 3b illustrates an external/sidestream membrane bioreactor (sMBR) configuration.

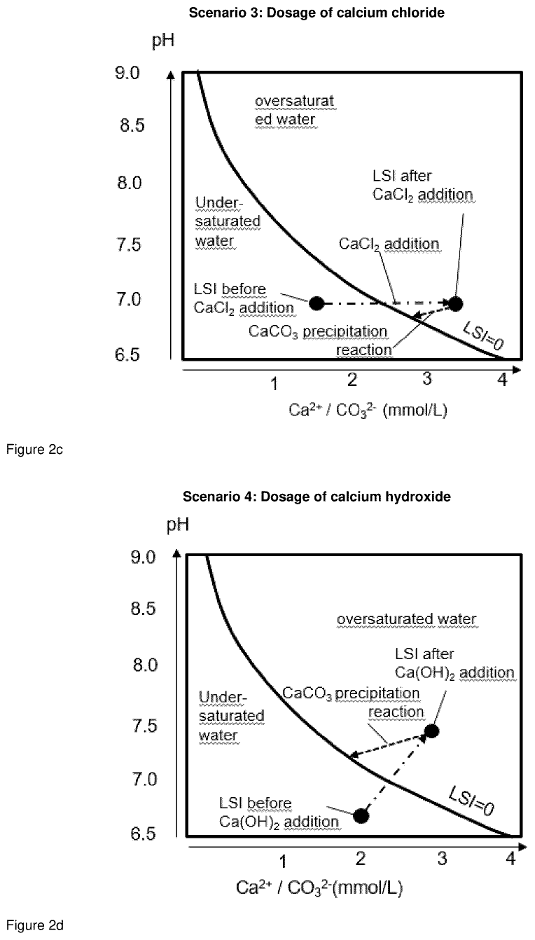

FIG. 4 illustrates a more specific configuration of an immersed/submerged membrane bioreactor (iMBR) configuration used in the examples.

### EXAMPLES

### 1. Analytical Methods

All parameters defined throughout the present application and mentioned in the following examples are based on the following measuring methods:

### Particle Size Distribution

Volume determined median particle size d₅₀ (vol) and the volume determined top cut particle size d₉₈ (vol) as well as the volume particle sizes d₉₀ (vol) and d₁₀ (vol) may be evaluated in a wet unit using a Malvern Mastersizer 2000 or 3000 Laser Diffraction System (Malvern Instruments Plc., Great Britain). If not otherwise indicated in the following example section, the volume particle sizes were evaluated in a wet unit using a Malvern Mastersizer 2000 Laser Diffraction System (Malvern Instruments Plc., Great Britain). The d₅₀ (vol) or d₉₈ (vol) value indicates a diameter value such that 50% or 98% by volume, respectively, of the particles have a diameter of less than this value. The raw data obtained by the measurement was analyzed using the Mie theory, with a particle refractive index of 1.57 and an absorption index of 0.005. The methods and instruments are known to the skilled person and are commonly used to determine particle size distributions of fillers and pigments. The sample was measured in dry condition without any prior treatment.

The weight determined median particle size d₅₀ (wt) was measured by the sedimentation method, which is an analysis of sedimentation behaviour in a gravimetric field. The measurement was made with a Sedigraph™ 5120 of Micromeritics Instrument Corporation, USA. The method and the instrument are known to the skilled person and are commonly used to determine particle size distributions of fillers and pigments. The measurement was carried out in an aqueous solution of 0.1 wt % Na₄P₂O₇. The samples were dispersed using a high speed stirrer and supersonicated.

The processes and instruments are known to the skilled person and are commonly used to determine particle sizes of fillers and pigments.

### BET Specific Surface Area of a Material

The “specific surface area” (expressed in m²/g) of a material as used throughout the present document is determined by the Brunauer Emmett Teller (BET) method with nitrogen as adsorbing gas and by use of a ASAP 2460 instrument from Micromeritics. The method is well known to the skilled person and defined in ISO 9277:2010. Samples are conditioned at 100° C. under vacuum for a period of 60 min prior to measurement. The total surface area (in m²) of said material can be obtained by multiplication of the specific surface area (in m²/g) and the mass (in g) of the material.

### Transmembrane Pressure

The transmembrane pressure (bar) measures the pressure drop across the membrane during filtration and is an indicator of how fouled the membrane is. This is measured by a pressure transducer located on the permeate pipework between the submerged membrane unit and the permeate pump. The pressure transducer is located as close as possible to the submerged membrane to minimize the impact of pressure losses from piping and fittings. The pressure transducer is located at the same height of the water level within the tank, to minimize the impact of static pressure differences. For the experiments mentioned below, the trans-membrane pressure was measured continuously by a pressure transducer (Vega Grieshaber KG, Schiltach, Germany). An average daily value was calculated.

### Flow

The flow (l/h) was measured continuously by a magnetic flow meter (Endress+Hauser Group Services AG, Reinach BL, Switzerland). An average daily value was calculated.

### Flux

The flux was calculated by dividing the flow value by the membrane surface area that was used for the filtration step. The value for flux is given as litres per square meter of membrane area per hour.

$$Flux ( {lh}^{- 1} {m}^{- 2} ) = \frac{Flow ( l / h )}{Membrane surface area ( {m}^{2} )}$$

### Permeability

The permeability (l h⁻¹ m⁻² bar⁻¹) was calculated based on the following relation:

$$Permeability ( {lh}^{- 1} {m}^{- 2} {bar}^{- 1} ) = \frac{Flow ( l / h )}{Transmembrane pressure ( bar ) \cdot membrane surface area ( {m}^{2} )}$$

wherein the membrane surface area is defined by the membrane surface of each membrane module indicated by the membrane manufacturer multiplied by the number of installed modules.
pH

Any pH value is measured at 25° C. using a Mettler-Toledo Seven Easy pH meter and a Mettler-Toledo InLab Expert Pro pH electrode. A three point calibration (according to the segment method) of the instrument is first made using commercially available buffer solutions having pH values of 4, 7 and 10 at 25° C. (from Aldrich). The reported pH values are the endpoint values detected by the instrument (signal differs by less than 0.1 mV from the average over the last 6 seconds).

### Alkalinity

The total alkalinity (CaCO₃) as referred to herein (sometimes referred to as “TAC”) is a measure of the ability of an aqueous solution to neutralize acids to the equivalence point of carbonate or bicarbonate. The alkalinity is equal to the stoichiometric sum of the bases in solution and is specified in mg/l (as CaCO₃).

The total alkalinity is measured with a Mettler-Toledo T70 Titrator using the corresponding LabX Light Titration software. A DGi111-SG pH electrode is used for this titration according to the corresponding Mettler-Toledo method M415 of the application brochure 37 (water analysis). The calibration of the pH electrode is performed using Mettler-Toledo pH standards (pH 4.01, 7.00 and 9.21).

### Water Hardness

Water hardness is the total calcium and magnesium ion concentration in a water sample and is expressed as the concentration of calcium carbonate.

The water hardness was measured by a colorimetric water hardness cuvette test supplied under the product No. LCK327 by Hach Lange GmbH, Düsseldorf, Germany.

### LSI (Langelier Saturation Index)

The LSI is expressed as the difference between the actual system pH and the saturation pH:

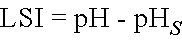

pH is the actual measured pH value of the aqueous system
pH₅ is the saturation pH value at which the solution is saturated with Ca²⁺ and CO₃²⁻ and is calculated by the following formula:

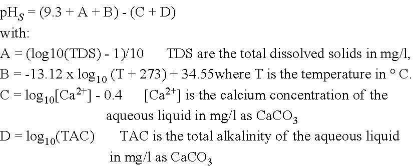

### 2. Equipment

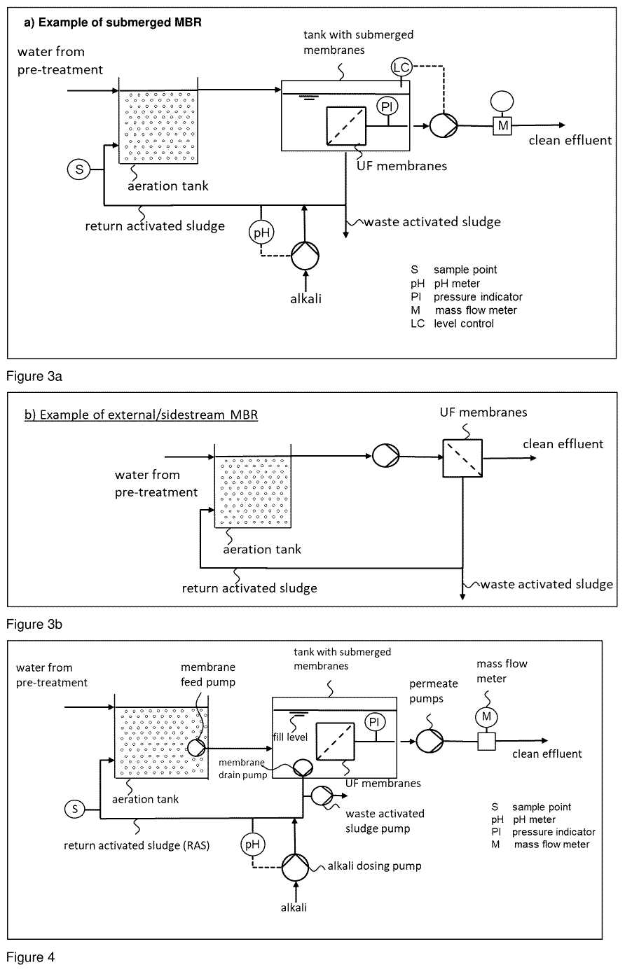

A more specific set-up of the exemplary installation is illustrated in FIG. 4.

The following equipment was used in the trials:
Aeration tank with a volume of 5000 m³.
Four 200 m³ membrane tanks with submerged ultrafiltration (UF) membranes comprising in total 2000 hollow fiber membrane modules manufactured by Zenon with 0.1 μm pore size and a total surface area of 75000 m². The modules were submerged in water and periodically cleaned by reversing water flow in combination with air scouring.
Four horizontal centrifugal permeate pumps with variable speed control to match effluent and influent flow.
Pressure indicator providing the transmembrane pressure (Vega Grieshaber KG, Schiltach, Germany).
Magnetic mass flow meters providing the flow across the membranes (Endress+Hauser Group Services AG, Reinach BL, Switzerland).
Pipelines and submersible pumps to transfer the MLSS (RAS) into the membrane tanks, drain membrane tanks to dispose waste activated sludge (WAS).
pH meter indicating the pH in the return activated sludge (pH electrode supplied by Hach Lange GmbH, Düsseldorf, Germany).
Pump providing alkali to maintain a constant pH value (diaphragm pump for NaOH and peristaltic pump for calcium carbonate suspension).

### 3. Chemicals

### Alkali:

Caustic soda is added in liquid form as a 25% solution.
Stabilized suspension of natural ground calcium carbonate (71 wt % solids content, d₅₀=1 μm; d₉₈=5 μm; BET specific area=12 m²/g; purity 98 wt %) is added in liquid form as a 71% suspension.

### 4. Wastewater Characteristics:

The wastewater at the inflow of the plant can be characterized by the following sum parameters: Total suspended solids (TSS)=150 mg/l, Biological oxygen demand (BOD)=200 mg/l, total nitrogen (TN)=45 mg/l.

### 5. Procedure

The municipal MBR plant was conventionally operated. The following procedures provide more details on the operation mode and trial procedure:

Municipal wastewater was continuously fed to the wastewater treatment plant by a pressurized sewer pipeline. The wastewater underwent two primary treatment steps consisting of grit removal and primary settling stages and thereafter flowed to the aeration basin by gravity.

The water was continuously treated in the equipment as depicted in FIG. 4 by an activated sludge process consisting of the following steps:
a) Contacting the wastewater with recycled activated sludge flocs. The MLSS was kept constant at 10000 mg/l. The water and return activated sludge were being contacted as they entered the aeration tank. The return activated sludge originated from the tank with submerged membranes.
b) Providing oxygen for microbial degradation of organic and inorganic compounds in the wastewater in the aeration tank by blowing ca. 15000 m³/h of air into the aeration tank.
c) Transferring the water to the tank with submerged UF membranes via a submersible pump and a pipeline.
d) Separating the treated water and the activated sludge by pumping it through the UF membranes, wherein the flow across the membranes was induced by a pump behind the membranes which provided a pressure difference across the membranes. The pump controlled the flow speed in such way that the effluent of the wastewater treatment plant matched the flow at the influent of the wastewater treatment plant.

The daily average flow to the system tank remained constant within ca. 5% fluctuations.

Accumulating sludge was recycled to the aeration tank by a pump submerged in the membrane tank.

From time to time surplus sludge was wasted in order to maintain a constant feed (organic matter in the influent) to mass (mixed liquor suspended solids in the system) ratio of ca. 0.1 kg biological oxygen demand per day per kg of mixed liquor suspended solids (in the complete system).

As an alkali, calcium carbonate slurry or 25% NaOH solution as comparative sample were added to the system. By the addition of the alkali, a constant pH of 6.5 was maintained.

In three trials (lasting between 11, 23 and 39 days), calcium carbonate suspension was added to the system in order to maintain a constant pH of 6.5.

In three control trials (lasting between 11, 23 and 39 days), caustic soda was added to the system in order to maintain a constant pH of 6.5.

Other than that, all parameters were kept constant.

The average amount of alkaline added per litre wastewater in table 1 relates to the mass weight of the compound added in one day, at theoretical 100% concentration, per volume of wastewater treated at that day. The mass weight relates to the weight of the alkaline contained in the respective solution/suspension, e.g. 41 mg NaOH means 164 g 25% caustic soda solution. 80 mg CaCO₃ means 113 g 71% calcium carbonate suspension, etc.

TABLE 1
Test Settings

| | | Average | | |
|---|---|---|---|---|
| | | amount | | |
| | | added per | Average | |
| | | litre | Langlier | Trial |
| | Alkalinity | wastewater | saturation | duration |
| Trial # | source | per day | index (LSI) | (days) |
| 1 (COMP) | 25% Caustic | 41 mg NaOH | −0.15 | 11 |
| | soda solution | | | |
| 2 (INV) | 71% | 80 mg CaCO3 | −0.15 | 11 |
| | Calcium | | | |
| | carbonate | | | |
| | suspension | | | |
| 3 (COMP) | 25% Caustic | 40 mg NaOH | −0.19 | 23 |
| | soda solution | | | |
| 4 (INV) | 71% | 64 mg CaCO3 | −0.25 | 23 |
| | Calcium | | | |
| | carbonate | | | |
| | suspension | | | |
| 5 (COMP) | 25% Caustic | 41 mg NaOH | −0.25 | 39 |
| | soda solution | | | |
| 6 (INV) | 71% | 75 mg CaCO3 | −0.43 | 39 |
| | Calcium | | | |
| | carbonate | | | |
| | suspension | | | |

TABLE 2
Test results

| | Average | Transmem- | | | | |
|---|---|---|---|---|---|---|
| | transmem- | brane | | | | |
| | brane | pressure | Average | | Average | Permeability |
| | pressure | STD | flux | Flux STD | permeability | STD |
| Trial # | (bar) | (bar) | (l□h⁻¹m⁻²□) | (l□h⁻¹m⁻²□) | (l□h⁻¹m⁻²bar⁻¹) | (l□h⁻¹m⁻²bar⁻¹) |
| 1 (COMP) | 0.0867 | 0.0084 | 17.73 | 0.62 | 204 | 20 |
| 2 (INV) | 0.0663 | 0.0038 | 19.66 | 0.43 | 296 | 17 |
| 3 (COMP) | 0.0797 | 0.0089 | 17.93 | 0.56 | 225 | 25 |
| 4 (INV) | 0.0612 | 0.0029 | 20.13 | 0.39 | 329 | 16 |
| 5 (COMP) | 0.0763 | 0.0035 | 18.47 | 0.50 | 242 | 11 |
| 6 (INV) | 0.0611 | 0.0023 | 19.81 | 0.42 | 324 | 12 |

The system performance and treated water parameters were comparable when caustic soda and calcium carbonate were used. Surprisingly, however, the average transmembrane pressure at constant flow was reduced and remained very low, when calcium carbonate was used to control the pH.

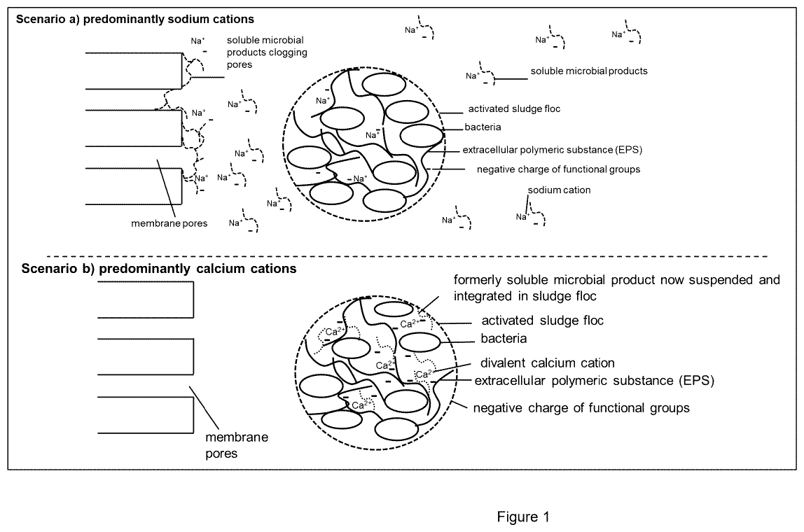

This means that the membrane permeability increased. It is believed that calcium cations improve the floc formation and thereby reduce organic bio-fouling which is known to be the main reason for reduced membrane permeability (see FIG. 1). The significantly increased permeability also indicates that calcium carbonate addition did not result in any inorganic fouling which, had it occurred, would have resulted in a decreased membrane permeability.

1. A process for the treatment of wastewater in a membrane bioreactor (MBR) process using at least one membrane module, comprising the steps of
a) providing wastewater,
b) contacting the wastewater of step a) with the at least one membrane module in the presence of sludge, and
c) adding calcium carbonate to the wastewater of step a) before and/or during step b).

2. The process according to claim 1,
wherein one part of the added calcium carbonate is dissolved, and the other part remains undissolved.

3. The process according to claim 1,
wherein the at least one membrane module of step b) is submerged in the bioreactor (iMBR) or installed outside the bioreactor in a sidestream (sMBR).

4. The process according to claim 1,
wherein the at least one membrane module has a pore size of not more than 5 μm.

5. The process according to claim 1,
wherein the pH value in the mixed liquor comprising sludge and calcium carbonate is from 5.5 to 9.

6. The process according to claim 1,
wherein the total alkalinity in the effluent is from 30 to 300 mg/l as CaCO₃.

7. The process according to claim 1,
wherein the Langelier Saturation Index (LSI) of the mixed liquor comprising sludge and calcium carbonate is from −1.5 to +1.

8. The process according to claim 1,
wherein the calcium carbonate is selected from the group comprising natural ground calcium carbonate (GCC), mixed natural ground carbonate minerals containing calcium carbonate, precipitated calcium carbonate (PCC), and mixtures thereof.

9. The process according to claim 8,
wherein the natural ground calcium carbonate (GCC) is selected from the group comprising marble, chalk, limestone, and mixtures thereof; the mixed natural ground carbonate mineral is dolomite; and the precipitated calcium carbonate (PCC) is selected from the group comprising precipitated calcium carbonates having aragonitic, vateritic or calcitic crystal forms, and mixtures thereof.

10. The process according to claim 1,
wherein the calcium carbonate has
a weight median particle diameter d₅₀ (wt) of from 0.1 to 50 μm, and/or
a top cut particle diameter d₉₈ (wt) of not more than 100 μm, and/or
a BET specific surface area of from 0.1 to 100 m²/g, and/or
a purity of at least 70 wt %.

11. The process according to claim 1,
wherein the calcium carbonate is provided in dry form or in the form of an aqueous suspension, or in the form of an aqueous suspension having a solids content of at least 60 wt %.

12. The process according to claim 1,
wherein the permeability of the at least one membrane module is increased by at least 10% by the addition of calcium carbonate.

13. The process according to claim 1,
wherein the flux rate of the at least one membrane module at a given pressure is increased by at least 5% by the addition of calcium carbonate.

14. (canceled)

15. A method for increasing the membrane permeability in a membrane bioreactor (MBR) process using at least one membrane module by adding calcium carbonate according to claim 1,
wherein the permeability of the at least one membrane module is increased by at least 10% by the addition of calcium carbonate.

16. The method for increasing the membrane flux rate in a membrane bioreactor (MBR) process using at least one membrane module by adding calcium carbonate according to claim 1,
wherein the flux rate of the at least one membrane module at a given pressure is increased by at least 5% by the addition of calcium carbonate.

17. The process according to claim 5, wherein the pH value in the mixed liquor comprising sludge and calcium carbonate is from 7 to 7.3.

18. The process according to claim 6, wherein the total alkalinity in the effluent is from 50 to 275 mg/l as CaCO₃.

19. The process according to claim 18, wherein the total alkalinity in the effluent is from 100 to 200 mg/l as CaCO₃.

20. The process according to claim 7, wherein the Langelier Saturation Index (LSI) of the mixed liquor comprising sludge and calcium carbonate is from −1.5 to 0.

21. The process according to claim 20, wherein the Langelier Saturation Index (LSI) of the mixed liquor comprising sludge and calcium carbonate is from −0.5 to 0.
